(19) United States
(12) Patent Application Publication
(10) Pub. No.: US 2026/0222258 A1
(43) Pub. Date: Jul. 30, 2026

(54) METHODS AND APPARATUSES FOR UPLINK POSITIONING

(71) Applicant: Lenovo (Beijing) Limited, Beijing (CN)

(72) Inventors: Jie Hu, Beijing (CN); Jing Han, Beijing (CN); Haiming Wang, Beijing (CN); Lihua Yang, Beijing (CN); Luning Liu, Beijing (CN)

(73) Assignee: Lenovo (Beijing) Limited, Beijing (CN)

(21) Appl. No.: 19/143,610

(22) PCT Filed: Jan. 5, 2023
(86) PCT No.: PCT/CN2023/070761

§ 371 Date: Jun. 26, 2025

(51) Int. Cl. H04L 27/26; H04W 76/27

(52) U.S. Cl. CPC H04L 27/261; H04W 76/27

(57) ABSTRACT

Embodiments of the present application are related to methods and apparatuses for uplink (UL) positioning. An embodiment of the present application provides a user equipment (UE) including: a transceiver and a processor coupled to the transceiver, 2024/073962 wherein the processor is configured to: receive, with the transceiver, validity area information including at least one validity area each of which consists of at least one cell; and receive, with the transceiver, sounding reference signal (SRS) configuration information including at least one SRS configuration for radio resource control (RRC) inactive or idle state, wherein the SRS configuration information is associated with the at least one validity area.

### TECHNICAL FIELD

The present disclosure generally relates to wireless communications, and especially to methods and apparatuses for uplink (UL) positioning.

### BACKGROUND OF THE INVENTION

In 3rd Generation Partnership Project (3GPP) Release 18 study for UL positioning, it is agreed that sounding reference signal (SRS) positioning validity area for UL positioning in radio resource control (RRC) inactive or idle state can avoid reconfiguration of SRS configuration upon cell reselection and it is also considered as feasible from both physical layer and high layer perspectives, which are recommended as a potential enhancement for UL configuration for a user equipment (UE), especially for, e.g., low power high accuracy positioning (LPHAP) UEs. In addition, pre-configuration of multiple SRS configurations (e.g., for multiple SRS positioning validity areas) is also supported as a way for a UE to acquire the configuration. To implement configuration or pre-configuration of SRS configuration(s) and associated validity area(s), the higher layer procedure and signaling details should be specified.

### SUMMARY

Some embodiments of the present disclosure provide a UE including: a transceiver and a processor coupled to the transceiver, wherein the processor is configured to: receive, with the transceiver, validity area information including at least one validity area each of which consists of at least one cell; and receive, with the transceiver, SRS configuration information including at least one SRS configuration for RRC inactive or idle state, wherein the SRS configuration information is associated with the at least one validity area.

In some embodiments, the processor is further configured to transmit, with the transceiver and to a location management function (LMF), positioning capability information indicating that the UE supports SRS configuration with validity area.

In some embodiments, the positioning capability information indicates a maximum number of validity area(s) supported by the UE.

In some embodiments, the SRS configuration information and the validity area information are received via RRC signaling.

In some embodiments, the validity area information includes: at least one list of cells constituting the at least one validity area, or at least one validity area identifier (ID) associated with the at least one validity area and mapping relationship between a set of validity area IDs associated with a set of validity areas and a set of lists of cells constituting the set of validity areas, wherein the set of validity areas include the at least one validity area.

In some embodiments, the validity area information is received via system information, and the SRS configuration information is received via RRC signaling.

In some embodiments, the validity area information includes mapping relationship between a set of validity area IDs associated with a set of validity areas and a set of lists of cells constituting the set of validity areas, wherein the set of validity areas include the at least one validity area.

In some embodiments, the processor is further configured to: receive, with the transceiver, at least one validity area ID along with the SRS configuration information, wherein the at least one validity area ID is mapped to at least one list of cells constituting the at least one validity area according to the mapping relationship.

In some embodiments, the processor is further configured to: transmit, with the transceiver, a request for validity area information associated with the SRS configuration information when the UE is in RRC inactive or idle state; and receive, with the transceiver, at least one validity area ID or at least one list of cells constituting the at least one validity area via an RRC signaling in response to the request, wherein the at least one validity area ID is mapped to the at least one list of cells constituting the at least one validity area according to the mapping relationship.

In some embodiments, the processor is further configured to transmit, with the transceiver, a request for validity area information associated with the SRS configuration information when the UE is in RRC inactive or idle state, wherein the validity area information is received via an RRC signaling in response to the request and includes at least one list of cells constituting the at least one validity area.

In some embodiments, the request is transmitted using a small data transmission (SDT) procedure, or via an RRC resume message, or via a random access channel (RACH) message.

In some embodiments, the SRS configuration information and the validity area information are received via system information.

In some embodiments, the SRS configuration information includes: 1) at least one SRS configuration ID and mapping relationship between a set of SRS configuration IDs associated with a set of SRS configurations including the at least one SRS configuration and a set of SRS configuration parameter sets corresponding to the set of SRS configurations, wherein the at least one SRS configuration ID is mapped to at least one SRS configuration parameter set corresponding to the at least one SRS configuration according to the mapping relationship, each SRS configuration parameter set corresponding to an SRS configuration; or 2) the at least one SRS configuration parameter set corresponding to the at least one SRS configuration.

In some embodiments, the validity area information includes: 1) at least one validity area ID and mapping relationship between a set of validity area IDs associated with a set of validity areas including the at least one validity area and a set of lists of cells constituting the set of validity areas, wherein the at least one validity area ID is mapped to at least one list of cells constituting the at least one validity area according to the mapping relationship; or 2) the at least one list of cells constituting the at least one validity area.

In some embodiments, the processor is further configured to receive, with the transceiver, an indication indicating an SRS configuration ID associated with an SRS configuration and a validity area ID associated with a validity area which is associated with the SRS configuration via RRC signaling.

In some embodiments, the processor is further configured to: transmit, with the transceiver, a request for an explicit SRS configuration ID associated with an SRS configuration and validity area information associated with a validity area which is associated with the SRS configuration; and receive, with the transceiver, an indication including: 1) the explicit SRS configuration ID, wherein the explicit SRS configuration ID is mapped to an SRS configuration parameter set corresponding to the SRS configuration according to mapping relationship between a set of SRS configuration IDs associated with a set of SRS configurations including the SRS configuration and a set of SRS configuration parameter sets corresponding to the set of SRS configurations, and 2) a validity area ID, wherein the validity area ID is mapped to a list of cells constituting the validity area according to mapping relationship between a set of validity area IDs associated with a set of validity areas including the validity area and a set of lists of cells constituting the set of validity areas, or the list of cells constituting the validity area.

In some embodiments, the processor is further configured to: transmit, with the transceiver, a request for an explicit SRS configuration parameter set corresponding to an SRS configuration and validity area information associated with a validity area which is associated with the SRS configuration; and receive, with the transceiver, an indication including: 1) the explicit SRS configuration parameter set, and 2) a validity area ID, wherein the validity area ID is mapped to a list of cells constituting the validity area according to the mapping relationship between a set of validity area IDs associated with a set of validity areas including the validity area and a set of lists of cells constituting the set of validity areas, or the list of cells constituting the validity area.

In some embodiments, the request is transmitted using an SDT procedure, or via an RRC resume message, or via a RACH message.

In some embodiments, the processor is further configured to: store the SRS configuration information and the validity area information, wherein the validity area information indicates a validity area ID associated with a validity area including a first cell where the validity area information is received, and the SRS configuration information includes an SRS configuration associated with the validity area; and keep using the SRS configuration in the case that the UE reselects or camps to a second cell when the UE is in RRC inactive or idle state, wherein validity area information received from the second cell indicates the same validity area ID as the stored validity area information.

In some embodiments, the processor is further configured to: store the SRS configuration information and the validity area information, wherein the validity area information indicates a list of cells constituting a validity area including a first cell where the validity area information is received, and the SRS configuration information includes an SRS configuration associated with the validity area; and keep using the SRS configuration in the case that the UE reselects or camps to a second cell when the UE is in RRC inactive or idle state, wherein the second cell is also included in the list of cells indicated by the stored validity area information.

In some embodiments, the processor is further configured to: receive, with the transceiver, positioning specific cell selection or reselection information for RRC inactive or idle state when the UE is in RRC connected state, wherein the positioning specific cell selection or reselection information includes allowed list(s) of cells associated with a same SRS configuration included in the SRS configuration information or includes allowed list(s) of cells within an area scope of a same validity area included in the validity area information; and prioritize cells in the allowed list(s) when the UE performs a cell selection or reselection.

Some embodiments of the present disclosure provide a base station (BS) including: a transceiver and a processor coupled to the transceiver, wherein the processor is configured to: transmit, with the transceiver and to a UE, validity area information including at least one validity area each of which consists of at least one cell; and transmit, with the transceiver and to the UE, SRS configuration information including at least one SRS configuration for RRC inactive or idle state, wherein the SRS configuration information is associated with the at least one validity area.

In some embodiments, the SRS configuration information and the validity area information are transmitted via RRC signaling.

In some embodiments, the validity area information includes: 1) at least one list of cells constituting the at least one validity area; or 2) at least one validity area ID associated with the at least one validity area and mapping relationship between a set of validity area IDs associated with a set of validity areas and a set of lists of cells constituting the set of validity areas, wherein the set of validity areas include the at least one validity area.

In some embodiments, the validity area information is transmitted via system information, and the SRS configuration information is transmitted via RRC signaling.

In some embodiments, the validity area information includes mapping relationship between a set of validity area IDs associated with a set of validity areas and a set of lists of cells constituting the set of validity areas, wherein the set of validity areas include the at least one validity area.

In some embodiments, the processor is further configured to transmit, with the transceiver and to the UE, at least one validity area ID along with the SRS configuration information, wherein the at least one validity area ID is mapped to at least one list of cells constituting the at least one validity area according to the mapping relationship.

In some embodiments, the processor is further configured to: receive, with the transceiver and from the UE, a request for validity area information associated with the SRS configuration information; and transmit, with the transceiver and to the UE, at least one validity area ID or at least one list of cells constituting the at least one validity area via an RRC signaling in response to the request, wherein the at least one validity area ID is mapped to the at least one list of cells constituting the at least one validity area according to the mapping relationship.

In some embodiments, the processor is further configured to receive, with the transceiver and from the UE, a request for validity area information associated with the SRS configuration information, wherein the validity area information is transmitted via an RRC signaling in response to the request and includes at least one list of cells constituting the at least one validity area.

In some embodiments, the request is received in an SDT procedure, or via an RRC resume message, or via a RACH message.

In some embodiments, the SRS configuration information and the validity area information are transmitted via system information.

In some embodiments, the SRS configuration information includes: 1) at least one SRS configuration ID and mapping relationship between a set of SRS configuration IDs associated with a set of SRS configurations including the at least one SRS configuration and a set of SRS configuration parameter sets corresponding to the set of SRS configurations, wherein the at least one SRS configuration ID is mapped to at least one SRS configuration parameter set corresponding to the at least one SRS configuration according to the mapping relationship, each SRS configuration parameter set corresponding to an SRS configuration; or 2) the at least one SRS configuration parameter set corresponding to the at least one SRS configuration.

In some embodiments, the validity area information includes: 1) at least one validity area ID and mapping relationship between a set of validity area IDs associated with a set of validity areas including the at least one validity area and a set of lists of cells constituting the set of validity areas, wherein the at least one validity area ID is mapped to at least one list of cells constituting the at least one validity area according to the mapping relationship; or 2) the at least one list of cells constituting the at least one validity area.

In some embodiments, the processor is further configured to transmit, with the transceiver and to the UE, an indication indicating an SRS configuration ID associated with an SRS configuration and a validity area ID associated with a validity area which is associated with the SRS configuration via RRC signaling.

In some embodiments, the processor is further configured to: receive, with the transceiver and from the UE, a request for an explicit SRS configuration ID associated with an SRS configuration and validity area information associated with a validity area which is associated with the SRS configuration; and transmit, with the transceiver and to the UE, an indication including: 1) the explicit SRS configuration ID, wherein the explicit SRS configuration ID is mapped to an SRS configuration parameter set corresponding to the SRS configuration according to mapping relationship between a set of SRS configuration IDs associated with a set of SRS configurations including the SRS configuration and a set of SRS configuration parameter sets corresponding to the set of SRS configurations, and 2) a validity area ID, wherein the validity area ID is mapped to a list of cells constituting the validity area according to mapping relationship between a set of validity area IDs associated with a set of validity areas including the validity area and a set of lists of cells constituting the set of validity areas, or the list of cells constituting the validity area.

In some embodiments, the processor is further configured to: receive, with the transceiver and from the UE, a request for an explicit SRS configuration parameter set corresponding to an SRS configuration and validity area information associated with a validity area which is associated with the SRS configuration; and transmit, with the transceiver and to the UE, an indication including: 1) the explicit SRS configuration parameter set, and 2) a validity area ID, wherein the validity area ID is mapped to a list of cells constituting the validity area according to mapping relationship between a set of validity area IDs associated with a set of validity areas including the validity area and a set of lists of cells constituting the set of validity areas, or the list of cells constituting the validity area.

In some embodiments, the request is received in an SDT procedure, or via an RRC resume message, or via a RACH message.

In some embodiments, the processor is further configured to: transmit, with the transceiver and to the UE, positioning specific cell selection or reselection information for RRC inactive or idle state via RRC signaling, wherein the positioning specific cell selection or reselection information includes allowed list(s) of cells associated with a same SRS configuration included in the SRS configuration information or includes allowed list(s) of cells within an area scope of a same validity area included in the validity area information, for the UE to perform a cell selection or reselection.

In some embodiments, the processor is further configured to: receive, with the transceiver and from an LMF, UL SRS transmission characteristics information, wherein the UL SRS transmission characteristics information indicates whether a UL SRS transmission is validity area specific or cell specific.

In some embodiments, in the case that the UL SRS transmission characteristics information indicates that the UL SRS transmission is validity area specific without providing a list of cells constituting a validity area, the processor is further configured to autonomously determine the at least one validity area and at least one list of cells constituting the at least one validity area.

In some embodiments, in the case that the UL SRS transmission characteristics information indicates that the UL SRS transmission is validity area specific and provides list(s) of cells constituting validity area(s), the processor is further configured to determine the at least one validity area and at least one list of cells constituting the at least one validity area based on the provided list(s) of cells.

In some embodiments, the processor is further configured to transmit, with the transceiver and to the LMF: information of transmission-reception points (TRPs) of cells within the at least one validity area, information of the at least one SRS configuration, and information of the at least one validity area.

In some embodiments, the information of the TRPs includes at least one of: physical cell identifiers (PCIs), global cell identifiers (GCIs) or TRP IDs of the TRPs; synchronization signal block (SSB) information of the TRPs; or geographical coordinates information of downlink (DL) positioning reference signal (PRS) resources of the TRPs.

In some embodiments, the information of the at least one validity area includes at least one of: 1) at least one validity area ID of the at least one validity area, and mapping relationship between the at least one validity area ID and at least one list of cells constituting the at least one validity area; or 2) the at least one list of cells constituting the at least one validity area.

In some embodiments, the processor is further configured to transmit, with the transceiver, the received UL SRS transmission characteristics information to other cell(s) within the at least one validity area to determine and align SRS configuration.

Some embodiments of the present disclosure provide an LMF including: a transceiver and a processor coupled to the transceiver, wherein the processor is configured to: receive, with the transceiver and from a UE, positioning capability information indicating that the UE supports SRS configuration with validity area; and transmit, with the transceiver and to a serving BS of the UE, UL SRS transmission characteristics information, wherein the UL SRS transmission characteristics information indicates whether a UL SRS transmission is validity area specific or cell specific.

In some embodiments, the positioning capability information indicates a maximum number of validity area(s) supported by the UE.

In some embodiments, in the case that the UL SRS transmission characteristics information indicates that the UL SRS transmission is validity area specific, the processor is further configured to receive, with the transceiver and from the serving BS: information of TRPs of cells within at least one validity area, information of the at least one SRS configuration, and information of the at least one validity area.

In some embodiments, the information of the TRPs includes at least one of: PCIs, GCIs or TRP IDs of the TRPs; SSB information of the TRPs; or geographical coordinates information of DL PRS resources of the TRPs.

In some embodiments, the information of the at least one validity area includes at least one of: 1) at least one validity area ID of the at least one validity area, and the mapping relationship between the at least one validity area ID and at least one list of cells constituting the at least one validity area; or 2) the at least one list of cells constituting the at least one validity area.

In some embodiments, in the case that the UL SRS transmission characteristics information indicates that the UL SRS transmission is validity area specific and provides an explicit list of cells constituting a validity area, the processor is further configured to transmit, with the transceiver, the UL SRS transmission characteristics information to each cell in the explicit list of cells.

In some embodiments, in the case that the UL SRS transmission characteristics information indicates that the UL SRS transmission is validity area specific, the processor is further configured to receive, with the transceiver and from each BS of one or more BSs including the serving BS: information of TRPs of cells of a respective BS within at least one validity area, and SRS configuration information for the cells of the respective BS within the at least one validity area.

Some embodiments of the present disclosure provide a method performed by a UE. The method includes: receiving validity area information including at least one validity area each of which consists of at least one cell; and receiving an SRS configuration information including at least one SRS configuration for RRC inactive or idle state, wherein the SRS configuration information is associated with the at least one validity area.

Some embodiments of the present disclosure provide a method performed by a BS. The method includes: transmitting validity area information including at least one validity area each of which consists of at least one cell; and transmitting an SRS configuration information including at least one SRS configuration for RRC inactive or idle state, wherein the SRS configuration information is associated with the at least one validity area.

Some embodiments of the present disclosure provide a method performed by an LMF. The method includes: receiving, from a UE, positioning capability information indicating that the UE supports SRS configuration with validity area; and transmitting, to a serving BS of the UE, UL SRS transmission characteristics information, wherein the UL SRS transmission characteristics information indicates whether a UL SRS transmission is validity area specific or cell specific.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method performed by a UE according to some embodiments of the present disclosure.

FIG. 3 illustrates a flowchart of an exemplary method performed by a BS according to some embodiments of the present disclosure.

FIG. 4 illustrates a flowchart of an exemplary method performed by an LMF according to some embodiments of the present disclosure.

FIG. 5 illustrates a flowchart of an exemplary method for UL positioning according to some embodiments of the present disclosure.

FIG. 6 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The present disclosure provides various solutions to implement configuration or pre-configuration of SRS configuration(s) and associated validity area(s) from both physical layer and high layer perspectives.

FIG. 1 is a schematic diagram illustrating an exemplary wireless communication system 100 according to some embodiments of the present disclosure.

As shown in FIG. 1, the wireless communication system 100 includes: at least one BS 101, at least one UE 102, and at least one LMF 103. Although one BS, one UE, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) RAN node, a node-B, an enhanced or evolved node B (eNB), a generalized node B (gNB), a home node-B, a relay node, or a device, or described using other terminology used in the art. The BS 101 is generally part of a RAN that may include a controller communicably coupled to the BS 101.

According to some embodiments of the present application, the UE 102 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102 may be an LPHAP UE.

According to some other embodiments of the present application, the UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102 may include wearable devices, such as smart watches, fitness bands, optical head-mounted displays, or the like.

Moreover, the UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

In the example shown in FIG. 1, when the UE 102 is in a coverage area of the BS 101, the UE 102 may communicate with the BS 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the BS 101 via, e.g., NR positioning protocol A (NRPPa) signaling, and may communicate with the UE 102 via, e.g., LTE positioning protocol (LPP) signaling. In the present disclosure, both LMF and BS may be referred to as a network entity or the network.

In some embodiments of the present disclosure, the BS 101 may configure or pre-configure at least one SRS configuration for RRC inactive or idle state for the UE 102. In the case that the UE 102 supports SRS configuration with validity area, the BS 101 may also configure or pre-configure at least one validity area associated with the at least one SRS configuration. For example, the BS 101 may configure or pre-configure an SRS configuration for RRC inactive or idle state and an associated validity area 105 when the UE 102 camps to cell 104a, wherein the validity area 105 may consist of at least one cell (e.g., cell 104a and cell 104b). When the UE 102 reselects to a new cell (e.g., cell 104b) within the validity area 105, it may keep using the SRS configuration associated with the validity area 105 and does not need to perform SRS reconfiguration.

In some embodiments, Xn connectivity is available between BSs within the same validity area.

In some embodiment of the present disclosure, a validity area may consist of at least one cell which is a subset of a RAN based notification area (RNA) or CN tracking area or equal to an RNA or CN tracking area. In some other embodiments, a validity area may include one or more specified neighboring cells surrounding a current serving cell or one or more cells within a specific range of the current serving cell. In some other embodiments, a validity area may consist of one or more cells under management of the same LMF. A network (e.g., wireless communication system 100) may provide different validity area definitions to different UEs, but does not mix different validity area definitions to the same UE at the same time.

According to some embodiments of the present disclosure, the SRS configuration(s) and associated validity area(s) are UE specific. In such embodiments, different UEs in the same cell may be provided with different SRS configuration(s) and validity area(s). That is, a cell may be mapped to different validity areas for different UEs.

According to some other embodiments of the present disclosure, the cell(s) that constitute each validity area are fixed, and the UEs in the same cell share the same validity area.

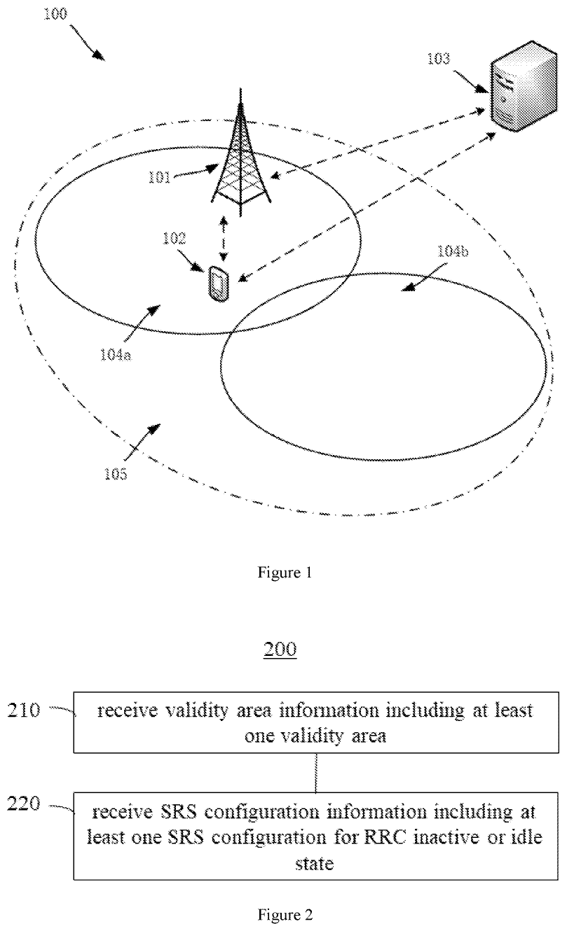

FIG. 2 illustrates a flowchart of an exemplary method 200 performed by a UE (e.g., the UE 102 in FIG. 1) according to some embodiments of the present disclosure. It is contemplated that the method 200 may also be performed by other devices with similar functions.

In step 210, the UE may receive validity area information, e.g., from a BS (e.g., the BS 101). The validity area information may include at least one validity area, and each validity area consists of at least one cell. In step 220, the UE may receive SRS configuration information including at least one SRS configuration for RRC inactive or idle state, e.g., from the BS. The SRS configuration information is associated with the at least one validity area included in the validity area information. In some embodiments, the SRS configuration information may be an information element (e.g., srs-Pos-Inactive) in RRC signaling or system information. It is contemplated that step 210 may be performed before, after, or simultaneously with step 220.

In some embodiments, the SRS configuration information includes a common SRS configuration parameter set, the validity area information includes one validity area consisting of at least one cell, and the common SRS configuration parameter set can be applied across the at least one cell constituting the one validity area.

In some embodiments, the SRS configuration information includes multiple SRS configuration parameter sets, the validity area information includes one validity area consisting of multiple cells, and each of the multiple SRS configuration parameter set is associated with a corresponding cell of the multiple cells.

In some embodiments, the SRS configuration information includes multiple SRS configuration parameter sets, the validity area information includes multiple validity areas, and each SRS configuration parameter set is associated with a corresponding validity area of the multiple validity areas and can be applied across the cell(s) constituting the corresponding validity area.

In some embodiments of the present disclosure, the UE may transmit positioning capability information to an LMF (e.g., the LMF 103). The positioning capability information may indicate that the UE supports SRS configuration with validity area for each uplink positioning method. In some embodiments, the positioning capability information may further indicate a maximum number of validity area(s) supported by the UE. In some embodiments, after the UE transmits the positioning capability information to the LMF, the LMF may coordinate with the BS (e.g., the BS 101) to direct the UE to transmit SRS for UL positioning, and the BS may transmit the validity area information and the SRS configuration information to the UE.

In some embodiments, the UE may indicate the positioning capability information to the LMF via an information element (e.g., NR-UL-ProvideCapabilities). For example, NR-UL-ProvideCapabilities may include a field (e.g., nr-ul-srs-Validity) indicating that the UE supports SRS configuration with validity conditions. The field nr-ul-srs-Validity may further include a subfield (e.g., area-validity) indicating that the UE supports SRS configuration with validity area. For example, the value of the subfield area-validity may be an integer number indicating a maximum number of validity area(s) supported by the UE.

According to some embodiments of the present disclosure, the UE may receive the SRS configuration information and the associated validity area information via RRC signaling when the UE is in RRC connected state. In some embodiments, the RRC signaling may be an RRC release message or other RRC messages.

In some embodiments, the validity area information may include at least one list of cells constituting the at least one validity area. That is, each list of cells consists of cell(s) constituting a corresponding validity area of the at least one validity area.

In some other embodiments, the validity area information may include:
1) at least one validity area ID associated with the at least one validity area, i.e., each validity area ID is associated with a corresponding validity area of the at least one validity area; and
2) mapping relationship between a set of validity area IDs associated with a set of validity areas and a set of lists of cells constituting the set of validity areas, wherein the set of validity areas include the at least one validity area.

In such embodiments, the UE may identify the at least one list of cells constituting the at least one validity area according to the at least one validity area ID and the mapping relationship between the set of validity area IDs and the set of lists of cells.

According to some embodiments of the present disclosure, the UE may receive the SRS configuration information via RRC signaling (e.g., an RRC release message or other RRC messages) when the UE is in RRC connected state and receive the validity area information via system information when the UE is in RRC connected, inactive or idle state.

In such embodiments, the validity area information received via system information may include mapping relationship between 1) a set of validity area IDs associated with a set of validity areas and 2) a set of lists of cells constituting the set of validity areas, wherein the set of validity areas include the at least one validity area.

In some embodiments, the UE may receive at least one validity area ID along with the SRS configuration information received via RRC signaling, wherein the at least one validity area ID is mapped to at least one list of cells constituting the at least one validity area according to the mapping relationship. The UE may identify the at least one list of cells constituting the at least one validity area according to 1) the at least one validity area ID received via RRC signaling and 2) the mapping relationship included in the validity area information received via system information.

In some embodiments, the UE does not receive validity area ID(s) along with the SRS configuration information. To acquire the at least one validity area associated with the SRS configuration information, the UE may transmit a request for validity area information associated with the SRS configuration information when the UE is in RRC inactive or idle state. For example, the UE may transmit the request by using a SDT procedure, via an RRC resume message, or via a RACH message. The UE may receive at least one validity area ID via RRC signaling in response to the request, wherein the at least one validity area ID is mapped to at least one list of cells constituting the at least one validity area according to the mapping relationship. According to the received at least one validity area ID and the mapping relationship, the UE may identify the at least one list of cells constituting the at least one validity area. In another embodiment, the UE may receive the at least one list of cells constituting the at least one validity area via RRC signalling in response to the request.

According to some embodiments of the present disclosure, the UE may receive the SRS configuration information via RRC signaling (e.g., an RRC release message or other RRC messages) when the UE is in RRC connected state, and no mapping relationship between a set of validity area IDs and a set of lists of cells is broadcasted in system information. In such embodiments, the UE may transmit a request, e.g., to the BS, for validity area information associated with the SRS configuration information when the UE is in RRC inactive or idle state. For example, the UE may transmit the request by using a SDT procedure, via an RRC resume message, or via a RACH message. The validity area information may be received via an RRC signaling in response to the request and include at least one list of cells constituting the at least one validity area.

According to some embodiments of the present disclosure, the UE may receive both the validity area information and the SRS configuration information via system information when the UE is in RRC connected, inactive or idle state.

In some embodiments, the SRS configuration information may include: 1) at least one SRS configuration ID and 2) mapping relationship between a set of SRS configuration IDs associated with a set of SRS configurations including the at least one SRS configuration and a set of SRS configuration parameter sets corresponding to the set of SRS configurations, wherein the at least one SRS configuration ID is mapped to at least one SRS configuration parameter set corresponding to the at least one SRS configuration according to the mapping relationship, and each SRS configuration parameter set corresponds to an SRS configuration. The UE may identify the at least one SRS configuration parameter set corresponding to the at least one SRS configuration according to the at least one SRS configuration ID and the mapping relationship included in the SRS configuration information.

In some other embodiments, the SRS configuration information may include the at least one SRS configuration parameter set corresponding to the at least one SRS configuration.

In some embodiments, the validity area information may include: 1) at least one validity area ID and 2) mapping relationship between a set of validity area IDs associated with a set of validity areas including the at least one validity area and a set of lists of cells constituting the set of validity areas, wherein the at least one validity area ID is mapped to at least one list of cells constituting the at least one validity area according to the mapping relationship. The UE may identify the at least one list of cells constituting the at least one validity area according to the at least one validity area ID and the mapping relationship included in the validity area information.

In some other embodiments, the validity area information may include the at least one list of cells constituting the at least one validity area.

In some embodiments, to acquire an explicit SRS configuration and an associated validity area, the UE may transmit a request, e.g., to the BS, for 1) an explicit SRS configuration ID associated with an SRS configuration and 2) validity area information associated with a validity area which is associated with the SRS configuration. For example, the UE may transmit the request by using a SDT procedure, via an RRC resume message, or via a RACH message. In response, the UE may receive an indication including: 1) the explicit SRS configuration ID and 2) an explicit validity area ID or an explicit list of cells constituting the validity area. The explicit SRS configuration ID is mapped to an SRS configuration parameter set corresponding to the SRS configuration according to mapping relationship (e.g., received via system information) between a set of SRS configuration IDs associated with a set of SRS configurations including the SRS configuration and a set of SRS configuration parameter sets corresponding to the set of SRS configurations. The explicit validity area ID is mapped to the list of cells constituting the validity area according to mapping relationship (e.g., received via system information) between a set of validity area IDs associated with a set of validity areas including the validity area and a set of lists of cells constituting the set of validity areas.

In some other embodiments, to acquire an explicit SRS configuration and an associated validity area, the UE may transmit a request, e.g., to the BS, for 1) an explicit SRS configuration parameter set corresponding to an SRS configuration and 2) validity area information associated with a validity area which is associated with the SRS configuration. For example, the UE may transmit the request by using a SDT procedure, via an RRC resume message, or via a RACH message. In response, the UE may receive an indication including: 1) the explicit SRS configuration parameter set and 2) an explicit validity area ID or an explicit list of cells constituting the validity area. The explicit validity area ID is mapped to the list of cells constituting the validity area according to mapping relationship (e.g., received via system information) between a set of validity area IDs associated with a set of validity areas including the validity area and a set of lists of cells constituting the set of validity areas.

According to some embodiments of the present disclosure, each cell may broadcast validity area information indicating a validity area ID associated with a validity area including the cell via system information or transmit such validity area information to UEs within the cell via RRC signaling. To avoid the interference or resource conflict between different validity areas, each cell can be mapped to only one validity area (and thus only one validity area ID). When the UE camps to a first cell, the UE may receive 1) validity area information indicating a validity area ID associated with a validity area including the first cell and 2) SRS configuration information including an SRS configuration associated with the validity area for RRC inactive or idle state. The UE may store the received SRS configuration information and validity area information. When the UE reselects or camps to a second cell in RRC inactive or idle state, the UE may receive validity area information indicating a validity area ID associated with a validity area including the second cell. If the validity area information received from the second cell indicates the same validity area ID as the stored validity area information, the UE may keep using the SRS configuration for RRC inactive or idle state received from the first cell.

According to some embodiments of the present disclosure, each cell may broadcast validity area information indicating a list of cells constituting a validity area including the cell via system information or transmit such validity area information to UEs within the cell via RRC signaling. When the UE camps to a first cell, the UE may receive 1) validity area information indicating a list of cells constituting a validity area including the first cell and 2) SRS configuration information including an SRS configuration associated with the validity area for RRC inactive or idle state. The UE may store the received SRS configuration information and validity area information. When the UE reselects or camps to a second cell in RRC inactive or idle state, if the second cell is also included in the list of cells indicated by the stored validity area information, the UE may keep using the SRS configuration for RRC inactive or idle state received from the first cell.

According to some embodiments of the present disclosure, a network (e.g., a BS) may indicate positioning specific cell selection or reselection information for RRC inactive or idle state to a UE when the UE is in RRC connected state, so as to facilitate the UE's reselecting a cell for positioning purpose in RRC inactive or idle state. For example, the UE may receive positioning specific cell selection or reselection information for RRC inactive or idle state from the BS via RRC signaling (e.g., RRC release message or other RRC messages) when the UE is in RRC connected state, wherein the positioning specific cell selection or reselection information may include allowed list(s) of cells associated with a same SRS configuration included in the SRS configuration information received from the BS or include allowed list(s) of cells within an area scope of a same validity area included in the validity area information received from the BS. When the UE performs a cell selection or reselection, the UE may take the above allowed list(s) of cells into consideration when perform ranking. For example, the UE may prioritize cells in the allowed list(s), i.e., the cells in the allowed list(s) may have a higher priority than other candidate cells.

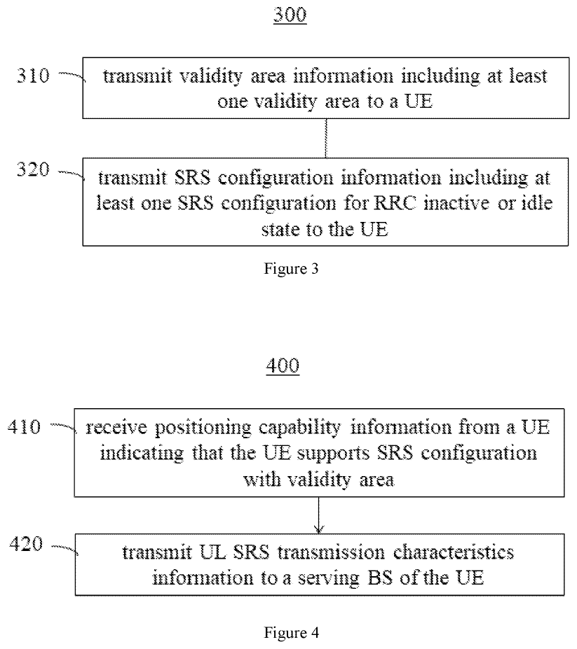

FIG. 3 illustrates a flowchart of an exemplary method 300 performed by a BS (e.g., the BS 101 in FIG. 1) according to some embodiments of the present disclosure. It is contemplated that the method 300 may also be performed by other devices with similar functions.

In step 310, the BS may transmit validity area information to a UE (e.g., the UE 102). The validity area information may include at least one validity area, and each validity area consists of at least one cell. In step 320, the BS may transmit SRS configuration information including at least one SRS configuration for RRC inactive or idle state to the UE. The SRS configuration information is associated with the at least one validity area included in the validity area information. In some embodiments, the SRS configuration information may be an information element (e.g., srs-Pos-Inactive) in RRC signaling or system information. It is contemplated that step 310 may be performed before, after, or simultaneously with step 320.

The definitions regarding the validity area information and the SRS configuration information provided in the embodiments described with respect to FIG. 2 may also apply here. It is contemplated that the BS may perform operations corresponding to those performed by the UE as described in the above embodiments. For example, in some embodiments, the BS may transmit the validity area information and the SRS configuration information via RRC signaling. In some embodiments, the BS may transmit the SRS configuration information via RRC signaling while transmitting the validity area information via system information. In some embodiments, the BS may transmit the validity area information and the SRS configuration information via system information. The validity area information and the SRS configuration information in different cases may include different contents as described above.

According to some embodiments of the present disclosure, the BS may transmit positioning specific cell selection or reselection information for RRC inactive or idle state to the UE via RRC signaling, wherein the positioning specific cell selection or reselection information may include allowed list(s) of cells associated with a same SRS configuration included in the SRS configuration information or includes allowed list(s) of cells within an area scope of a same validity area included in the validity area information, for the UE to perform a cell selection or reselection.

According to some embodiments of the present disclosure, the BS may coordinate with an LMF to determine the SRS configuration and validity area information. Either the BS or the LMF may be the entity to determine a validity area of a specific SRS configuration for RRC inactive or idle state for the UE. The coordination between the BS and the LMF may be performed before the BS transmits the validity area information and the SRS configuration information to the UE. Exemplary operations of the coordination will be described below with respect to FIG. 4.

FIG. 4 illustrates a flowchart of an exemplary method 400 performed by an LMF (e.g., the LMF 103 in FIG. 1) according to some embodiments of the present disclosure. It is contemplated that the method 400 may also be performed by other devices with similar functions.

In step 410, the LMF may receive positioning capability information from a UE (e.g., the UE 102), wherein the positioning capability information indicates that the UE supports SRS configuration with validity area. In some embodiments, the positioning capability information may indicate a maximum number of validity area(s) supported by the UE. In step 420, the LMF may transmit UL SRS transmission characteristics information to a serving BS (e.g., the BS 101) of the UE, wherein the UL SRS transmission characteristics information indicates whether a UL SRS transmission is validity area specific or cell specific. The UL SRS transmission characteristics information transmitted by the LMF is also referred to as “requested UL-SRS transmission characteristics information,” which may indicate characteristics of SRS to be transmitted by the UE for the time period required to perform uplink measurement. These characteristics should be static over the periodic transmission of SRS during the uplink measurements.

According to some embodiments of the present disclosure, the UL SRS transmission characteristics information is transmitted from the LMF to the serving BS via NRPPa signaling. For example, the UL SRS transmission characteristics information may include a “Cell-specific/Validity area specific” field indicating whether the UL SRS transmission is cell specific or validity area specific. In the case that the UL SRS transmission is indicated to be cell specific, it means that SRS configuration information is cell specific and the serving BS may determine cell-specific resource(s) for the UL SRS transmission. In such a case, when the UE camps or reselects to any new cell, SRS reconfiguration is performed in the new cell. In the case that the UL SRS transmission is indicated to be validity area specific, it means that SRS configuration information is validity area specific and the serving BS may determine validity area-specific resource(s) for the UL SRS transmission. In such a case, same SRS configuration information may be used across multiple cells constituting a validity area associated with the same SRS configuration information, and the UE in RRC inactive or idle state does not need to perform SRS reconfiguration upon reselecting to a new cell within the validity area.

In some embodiments, in the case that the UL SRS transmission characteristics information indicates that the UL SRS transmission is validity area specific, the UL SRS transmission characteristics information may further provide at least one explicit list of cells constituting at least one validity area. For example, the UL SRS transmission characteristics information may include an optional field (e.g., “Explicit cell list of the validity area”) providing at least one explicit list of cells constituting at least one validity area associated with the determined SRS configuration information.

In some embodiments, the LMF may transmit the same UL SRS transmission characteristics information including an explicit list of cells constituting a validity area to each cell in the explicit list of cells to indicate these cells to align an SRS configuration across the cells within the validity area, to avoid SRS reconfiguration when the UE in RRC inactive or idle state reselects to a new cell within the validity area. In some embodiments, the LMF may transmit the UL SRS transmission characteristics information including an explicit list of cells constituting a validity area to the serving BS, and the serving BS may transmit the UL SRS transmission characteristics information received from the LMF to other cell(s) in the explicit list of cells via Xn interface to determine and align an SRS configuration with other cell(s) constituting the at least one validity area, to avoid SRS reconfiguration when the UE in RRC inactive or idle state reselects to a new cell within the validity area.

In some embodiments, in the case that the UL SRS transmission characteristics information indicates that the UL SRS transmission is validity area specific without providing a list of cells constituting a validity area, the serving BS may autonomously determine at least one validity area associated with the SRS configuration information determined by the serving BS and at least one list of cells constituting the at least one validity area.

In some embodiments, in the case that the UL SRS transmission characteristics information indicates that the UL SRS transmission is validity area specific and provides list(s) of cells constituting validity area(s), the serving BS may determine the SRS configuration information, at least one validity area associated with the SRS configuration information and at least one list of cells constituting the at least one validity area based on the list(s) of cells provided by the UL SRS transmission characteristics information.

In some embodiments, the serving BS may coordinate with other cell(s) constituting the at least one validity area, e.g., by transmitting the UL SRS transmission characteristics information received from the LMF to the other cell(s) via Xn interface, to determine and align SRS configuration information with the other cell(s) constituting the at least one validity area.

In some embodiments, in the case that the UL SRS transmission characteristics information indicates that the UL SRS transmission is validity area specific, after determining at least one SRS configuration, at least one validity area associated with the at least one SRS configuration, and the at least one list of cells constituting the at least one validity area (autonomously or based on list(s) of cells constituting validity area(s) provided by the LMF), the serving BS may further transmit the following information to the LMF: 1) information of TRPs of cells within the at least one validity area, 2) information of the at least one SRS configuration, and 3) information of the at least one validity area associated with the at least one SRS configuration.

In some embodiments, the information of the TRPs may include at least one of: 1) PCIs, GCIs or TRP IDs of the TRPs, 2) SSB information of the TRPs (e.g., time/frequency occupancy of SSBs), or 3) geographical coordinates information of DL PRS resources of the TRPs. In some embodiments, the serving BS may transmit the information of the TRPs to the LMF via NRPPa signaling, e.g., assistance data information.

In some embodiments, the information of the at least one SRS configuration may include the at least one SRS configuration, and the information of the at least one validity area may include at least one of: 1) at least one validity area ID of the at least one validity area associated with the at least one SRS configuration, and mapping relationship between the at least one validity area ID and at least one list of cells constituting the at least one validity area; or 2) the at least one list of cells constituting the at least one validity area associated with the at least one SRS configuration. In some embodiments, the serving BS may transmit the information of the at least one SRS configuration and the information of the at least one validity area associated with the at least one SRS configuration to the LMF via NRPPa signaling, e.g., UE configuration data.

In some embodiments, the serving BS may transmit information of TRPs and SRS configuration information for each cell in the at least one list of cells to the LMF. In some other embodiments, each BS within the at least one validity area (including the serving BS) may transmit the following to the LMF: 1) information of TRPs of cells of a respective BS within the at least one validity area, and 2) SRS configuration information for the cells of the respective BS within the at least one validity area.

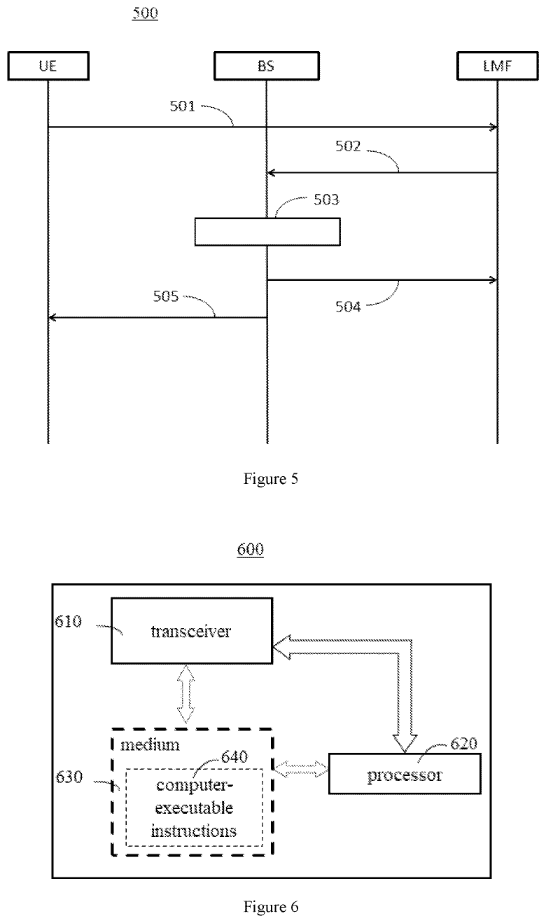

FIG. 5 illustrates a flowchart of an exemplary method 500 for UL positioning according to some embodiments of the present disclosure. The method 500 illustrated in FIG. 5 may be performed by at least three network entities, e.g., a UE (e.g., the UE 102), a BS (e.g., the BS 101), and an LMF (e.g., the LMF 103). Although the method is illustrated in a system level, persons skilled in the art can understand that the method implemented in the three network entities can be separately implemented and incorporated in other apparatus with the like functions. It is also contemplated that the method 500 may include additional steps not shown.

As shown in FIG. 5, the UE may transmit positioning capability information indicating that the UE supports SRS configuration with validity area to the LMF in step 501. In some embodiments, the positioning capability information indicates a maximum number of validity area(s) supported by the UE.

In some embodiments, in step 502, the LMF may transmit UL SRS transmission characteristics information to the BS, which is a serving BS of the UE, wherein the UL SRS transmission characteristics information indicates that the UL SRS transmission is validity area specific without providing an explicit list of cells constituting a validity area. In step 503, the BS may determine an SRS configuration and autonomously determine a validity area associated with the SRS configuration and an explicit list of cells constituting the validity area, and may coordinate with other cells in the list of cells to align the SRS configuration associated with the validity area, to avoid reconfiguration of SRS configuration when the UE in RRC inactive or idle state reselects to a new cell within the validity area.

In some other embodiments, in step 502, the LMF may transmit UL SRS transmission characteristics information to the BS, wherein the UL SRS transmission characteristics information indicates that the UL SRS transmission is validity area specific and provides list(s) of cells constituting validity area(s). In step 503, the BS may determine an SRS configuration, and determine a validity area associated with the SRS configuration and an explicit list of cells (including the serving cell) constituting the validity area based on the provided list(s) of cells, and may coordinate with other cells in the list of cells to align the SRS configuration associated with the validity area, to avoid reconfiguration of SRS configuration when the UE in RRC inactive or idle state reselects to a new cell within the validity area.

In step 504, the BS may transmit information of TRPs of the determined explicit list of cells constituting the validity area, information of the determined SRS configuration, and information of the validity area associated with the determined SRS configuration to the LMF. The information of the TRPs includes at least one of: 1) PCIs, GCIs or TRP IDs of the TRPs; 2) SSB information of the TRPs (e.g., time/frequency occupancy of SSBs); 3) geographical coordinates information of DL PRS resources of the TRPs. The information of the determined SRS configuration includes the determined SRS configuration. The information of the validity area associated with the determined SRS configuration includes at least one of: 1) the validity area ID of the validity area associated with the determined SRS configuration, and mapping relationship between a set of validity area IDs including the validity area ID and a set of lists of cells including the list of cells constituting the validity area; or 2) the list of cells constituting the validity area associated with the determined SRS configuration.

In some embodiments, in step 505, the BS may transmit validity area information and SRS configuration information to the UE. The definitions regarding the validity area information and the SRS configuration information and related operations provided in the embodiments described with respect to FIGS. 2 and 3 may also apply here.

FIG. 6 illustrates a simplified block diagram of an exemplary apparatus 600 according to some embodiments of the present disclosure.

In some embodiments, the apparatus 600 may be or include at least part of a UE which is capable of performing any of the operations performed by a UE as described in the present disclosure (e.g., in method 200 described with respect to FIGS. 2 and 5).

In some embodiments, the apparatus 600 may be or include at least part of a BS which is capable of performing any of the operations performed by a BS as described in the present disclosure (e.g., in method 300 described with respect to FIGS. 3 and 5).

In some embodiments, the apparatus 600 may be or include at least part of an LMF which is capable of performing any of the operations performed by an LMF as described in the present disclosure (e.g., in method 400 described with respect to FIGS. 4 and 5).

As shown in FIG. 6, the apparatus 600 may include at least a transceiver 610 and a processor 620 coupled to transceiver 610. In some embodiments, the transceiver 610 may include a transmitter and a receiver integrated together. In some embodiments, the transceiver 610 may include a transmitter and a receiver which are separated from each other. In some embodiments, the transceiver 610 may be a wireless transceiver.

In some embodiments, the apparatus 600 may include a non-transitory computer-readable medium 630 with computer-executable instructions 640 stored thereon. The non-transitory computer-readable medium 630 may be coupled to the processor 620 and the transceiver 610, and the computer-executable instructions 640 may be configured to be executable by the processor 620. In some embodiments, the transceiver 610, the non-transitory computer-readable medium 630, and the processor 620 may be coupled to each other via one or more local buses.

Although in FIG. 6, elements such as the transceiver 610, the non-transitory computer-readable medium 630, and the processor 620 are described in the singular, the plural is contemplated unless limitation to the singular is explicitly stated. In certain embodiments of the present disclosure, the apparatus 600 may further include other components for actual usage.

In various example embodiments, the processor 620 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 620 may also include at least one other circuitry or element not shown in FIG. 6.

In various example embodiments, the non-transitory computer-readable medium 630 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 630 may include, but is not limited to, an electric, a magnetic, an optical, an electromagnetic, an infrared, or a semiconductor system, apparatus, or device or any combination of the above.

Further, in various example embodiments, the apparatus 600 may also include at least one other circuitry, element, and interface, for example antenna element, and the like.

According to some embodiments, the apparatus 600 is a UE. The transceiver 610 and the processor 620 may be configured to perform operations in any methods described above which are performed by a UE. For example, the processor 620 may be configured to receive, with the transceiver 610, validity area information including at least one validity area each of which consists of at least one cell, and SRS configuration information including at least one SRS configuration for RRC inactive or idle state, wherein the SRS configuration information is associated with the at least one validity area.

According to some embodiments, the apparatus 600 is a BS. The transceiver 610 and the processor 620 may be configured to perform operations in any methods described above which are performed by a BS. For example, the processor 620 may be configured to transmit, with the transceiver 610 and to a UE, validity area information including at least one validity area each of which consists of at least one cell, and SRS configuration information including at least one SRS configuration for RRC inactive or idle state, wherein the SRS configuration information is associated with the at least one validity area.

According to some embodiments, the apparatus 600 is an LMF. The transceiver 610 and the processor 620 may be configured to perform operations in any methods described above which are performed by an LMF. For example, the processor 620 may be configured to receive, with the transceiver 610 and from a UE, positioning capability information indicating that the UE supports SRS configuration with validity area, and transmit, with the transceiver and to a serving BS of the UE, UL SRS transmission characteristics information, wherein the UL SRS transmission characteristics information indicates whether a UL SRS transmission is validity area specific or cell specific.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.” In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive validity area information including at least one validity area each of which consists of at least one cell; and
receive sounding reference signal (SRS) configuration information including at least one SRS configuration for radio resource control (RRC) inactive or idle state, wherein the SRS configuration information is associated with the at least one validity area.

2. The UE of claim 1, wherein to receive the SRS configuration information and the validity area information, the at least one processor is configured to cause the UE to:
receive the SRS configuration information and the validity area information via RRC signaling.

3. The UE of claim 2, wherein the validity area information includes:
at least one list of cells constituting the at least one validity area; or
at least one validity area identifier (ID) associated with the at least one validity area and mapping relationship between a set of validity area identifiers (IDs) associated with a set of validity areas and a set of lists of cells constituting the set of validity areas, wherein the set of validity areas include the at least one validity area.

4. The UE of claim 1, wherein to receive the validity area information, the at least one processor is configured to cause the UE to receive the validity area information via system information, and to receive the SRS configuration information, the at least one processor is configured to cause the UE to receive the SRS configuration information via RRC signaling.

5. The UE of claim 4, wherein the validity area information includes a mapping relationship between a set of validity area identifiers (IDs) associated with a set of validity areas and a set of lists of cells constituting the set of validity areas and, wherein the set of validity areas includes the at least one validity area.

6. The UE of claim 5, wherein the at least one processor is further configured to cause the UE to:
receive at least one validity area identifier (ID) along with the SRS configuration information, wherein the at least one validity area ID is mapped to at least one list of cells constituting the at least one validity area according to the mapping relationship.

7. The UE of claim 5, wherein the at least one processor is further configured to cause the UE to:
transmit a request for validity area information associated with the SRS configuration information when the UE is in the RRC inactive or idle state; and
receive at least one validity area identifier (ID) or at least one list of cells constituting the at least one validity area via an RRC signaling in response to the request, wherein the at least one validity area ID is mapped to the at least one list of cells constituting the at least one validity area according to the mapping relationship.

8. The UE of claim 1, wherein to receive the SRS configuration information and the validity area information, the at least one processor is configured to cause the UE to receive the SRS configuration information and the validity area information via system information.

9. The UE of claim 8, wherein the SRS configuration information includes:
at least one SRS configuration identifier (ID) and a mapping relationship between a set of SRS configuration identifiers (IDs) associated with a set of SRS configurations including the at least one SRS configuration and a set of SRS configuration parameter sets corresponding to the set of SRS configurations, wherein the at least one SRS configuration ID is mapped to at least one SRS configuration parameter set corresponding to the at least one SRS configuration according to the mapping relationship, and wherein each SRS configuration parameter set corresponds to an SRS configuration; or
the at least one SRS configuration parameter set corresponding to the at least one SRS configuration.

10. The UE of claim 8, wherein the validity area information includes:
at least one validity area identifier (ID) and a mapping relationship between a set of validity area identifiers (IDs) associated with a set of validity areas including the at least one validity area and a set of lists of cells constituting the set of validity areas, wherein the at least one validity area ID is mapped to at least one list of cells constituting the at least one validity area according to the mapping relationship; or
the at least one list of cells constituting the at least one validity area.

11. The UE of claim 8, wherein the at least one processor is further configured to cause the UE to:
transmit a request for an explicit SRS configuration identifier (ID) associated with an SRS configuration and validity area information associated with a validity area which is associated with the SRS configuration; and
receive an indication including:
the explicit SRS configuration ID, wherein the explicit SRS configuration ID is mapped to an SRS configuration parameter set corresponding to the SRS configuration according to a mapping relationship between a set of SRS configuration identifiers (IDs) associated with a set of SRS configurations including the SRS configuration and a set of SRS configuration parameter sets corresponding to the set of SRS configurations, and
a validity area ID, wherein the validity area ID is mapped to a list of cells constituting the validity area according to a mapping relationship between a set of validity area IDs associated with a set of validity areas including the validity area and a set of lists of cells constituting the set of validity areas, or the list of cells constituting the validity area.

12. A base station (BS) for wireless communication, comprising:
at least one memory; and
at least one processor coupled with the at least one memory and configured to cause the BS to:
transmit validity area information including at least one validity area each of which consists of at least one cell; and
transmit sounding reference signal (SRS) configuration information including at least one SRS configuration for radio resource control (RRC) inactive or idle state, wherein the SRS configuration information is associated with the at least one validity area.

13. The BS of claim 12, wherein the at least one processor is further configured to cause the BS to:
receive uplink (UL) SRS transmission characteristics information, wherein the UL SRS transmission characteristics information indicates whether a UL SRS transmission is validity area specific or cell specific.

14. The BS of claim 13, wherein in a case that the UL SRS transmission characteristics information indicates that the UL SRS transmission is validity area specific and provides list(s) of cells constituting validity area(s), the at least one processor is further configured to cause the BS to determine the at least one validity area and at least one list of cells constituting the at least one validity area based at least in part on the provided list(s) of cells.

15. The BS of claim 14, wherein the at least one processor is further configured to cause the BS to transmit one or more of:
information of transmission-reception points (TRPs) of cells within the at least one validity area,
information of the at least one SRS configuration, or
information of the at least one validity area.

16. A method performed by a user equipment (UE), the method comprising:
receiving validity area information including at least one validity area each of which consists of at least one cell; and
receiving sounding reference signal (SRS) configuration information including at least one SRS configuration for radio resource control (RRC) inactive or idle state, wherein the SRS configuration information is associated with the at least one validity area.

17. The method of claim 16, wherein receiving the SRS configuration information comprises:
receiving the SRS configuration information and the validity area information via RRC signaling.

18. The method of claim 17, wherein the validity area information includes:
at least one list of cells constituting the at least one validity area; or
at least one validity area identifier (ID) associated with the at least one validity area and mapping relationship between a set of validity area identifiers (IDs) associated with a set of validity areas and a set of lists of cells constituting the set of validity areas, wherein the set of validity areas include the at least one validity area.

19. A method performed by a base station (BS), the method comprising:
transmitting validity area information including at least one validity area each of which consists of at least one cell; and
transmitting sounding reference signal (SRS) configuration information including at least one SRS configuration for radio resource control (RRC) inactive or idle state, wherein the SRS configuration information is associated with the at least one validity area.

20. The method of claim 19, further comprising:
receiving uplink (UL) SRS transmission characteristics information, wherein the UL SRS transmission characteristics information indicates whether a UL SRS transmission is validity area specific or cell specific.
